(19) United States
(12) Patent Application Publication
(10) Pub. No.: US 2005/0085264 A1
(43) Pub. Date: Apr. 21, 2005

(54) Card wireless communication apparatus and power control method thereof

(76) Inventor: Masafumi Matsumura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/930,800

(22) Filed: Sep. 1, 2004

(30) Foreign Application Priority Data
Sep. 1, 2003 (JP) 2003-308840

(51) Int. Cl. H04B 1/38

(52) U.S. Cl. 455/558; 455/557

(57) ABSTRACT

Electric power control method for card wireless communication apparatus has interface installable in host unit and processor receiving electric power from host unit and conforms to communication standards where high-order protocol stack including adaptable protocol to emulate serial port communication and low-order protocol stack have been formulated, the electric power control method including starting step of causing the processor to carry out process related to low-order protocol stack in a first mode corresponding to case where the card wireless communication apparatus is installed in host unit high-order protocol stack is implemented in, a decision step of determining whether process related to low-order protocol stack stands idle after starting step, and shift step of bringing the processor into power-saving mode when it has been determined in the decision step that process related to the low-order protocol stack stands idle.

### CROSS-REFERENCE TO RELATED APPLICATIONS

This application is based upon and claims the benefit of priority from prior Japanese Patent Application No. 2003-308840, filed Sep. 1, 2003, the entire contents of which are incorporated herein by reference.

### BACKGROUND OF THE INVENTION

1. Field of the Invention

This invention relates to a card wireless communication apparatus, such as an SD IO card, and a power control method thereof.

2. Description of the Related Art

PC cards have been widely used to increase the storage capacity of notebook PCs or expand their Input/Output functions. In recent years, handheld devices, including notebook PCs, Personal Digital Assistants (PDAs), mobile phones, and cameras, have been getting smaller. In parallel with this, there have been strong demands toward the standardization of small cards. To meet the demands, the SDA (SD Association) has been pushing ahead with the standardization of stamp-sized Secure Digital (SD, trademark) cards.

The SD card specifications include the SD Memory specifications and the SD Input/Output specifications (SD IO specifications) for realizing various I/O functions. In 2001, SD IO card specifications have been formulated into specifications which are independent of the functions unique to I/O cards and feature common SD IO (refer to “Simplified Version of Secure Digital Input/Output (SDIO) Card Specification Version 1.00,” SD Association, 2001-10).

Recently, Bluetooth (a registered trademark of Bluetooth SIG, inc.) has attracted attention. Bluetooth is the standard for realizing data transmission and reception by connecting a plurality of portable devices by wireless. By combining SD card technology and Bluetooth technology, the development of small-size Bluetooth cards conforming to the SD IO card specifications has been in progress.

In SD IO card for Bluetooth specifications, common interface specifications and common register specifications for an SD card host unit with an SD card slot to access the Bluetooth function have been formulated in a higher-level layer conforming to common SD IO specifications. The host unit can use the Bluetooth function of a card conforming to the SD IO cards for Bluetooth specifications by a common access method and a common driver software program. The SD IO cards for Bluetooth specifications, which were formulated by the SDA in 2002, have been defined in the following two types.

[Type-A Card Specification] (SDIO Card Type-A Specification for Bluetooth)

Type-A card specification is for processing, within a card, layers lower than the Bluetooth HCI (Host Controller Interface), including Radio Frequency (RF), baseband, and Link Manager Protocol (LMP).

[Type-B Card Specification] (SDIO Card Type-B Specification for Bluetooth)

Type-B card specification is for processing, within a card, not only RF, baseband, and LMP but also much higher-level Bluetooth control protocols, including Logical Link Control and Adaptation Protocol (L2CAP), Service Discovery Protocol (SDP), and RFCOMM (serial port communication emulation).

Type-B cards can operate not only in the Type-B card operation mode (hereinafter, referred to as Type-B mode) but also in the Type-A mode of the same interface as Type-A cards. In addition, each card vendor can expand the functions of Type-B cards by implementing not only the protocol/profile to be implemented according to the specification but also another protocol/profile.

The Type-B mode of Type-B cards is based on the assumption that they are used in a host unit which is limited heavily in terms of CPU capability and memory resources. Such units include digital cameras and information household electrical appliances. Since a device having leeway in the CPU capability and memory resources, such as a PC or a PDA, has a Bluetooth high-order stack implemented therein in most cases, the Type-A mode of Type-A cards or Type-B cards is used.

This type of card wireless communication apparatus operates, receiving electric power from a host unit to which the communication apparatus is connected. Therefore, the power management method in the card wireless communication apparatus can affect the operating time of the host unit. In a situation where an SD IO card installed in a portable terminal is used, if the card wireless communication apparatus consumed a lot of electric power, the continuous driving time of the built-in battery might become shorter. In a card wireless communication apparatus capable of switching between operation modes (e.g., a Type-B card), power is not managed on an operation mode basis under the present conditions. Therefore, the continuous driving time of the host device might become shorter.

### BRIEF SUMMARY OF THE INVENTION

According to an aspect of the present invention, there is provided a card wireless communication apparatus which has an interface installable in a host unit and conforms to communication standards where a high-order protocol stack including an adaptable protocol to emulate serial port communication and a low-order protocol stack closer to a physical layer than the high-order protocol stack have been formulated, the card wireless communication apparatus comprises a processor which receives electric power from the host unit and operates; a first control section which causes the processor to carry out a process related to the low-order protocol stack; a second control section which causes the processor to carry out a process related to the high-order protocol stack; a mode switching section which starts the first control section in a first mode corresponding to a case where the apparatus is installed the host unit in which the high-order protocol stack is implemented and establishes a wireless communication environment in the first mode between the host unit and an external unit and which starts the first and second control sections in a second mode corresponding to a case where the apparatus is installed in the host unit in which the high-order protocol stack is not implemented and establishes a wireless communication environment in the second mode between the host unit and the external unit; a decision section which determines whether the operating state of the first control section is idle and whether the operating state of the second control section is idle; and a power control section which brings the processor into a power-saving mode, in one of a case where the decision section has determined that the first control section is in the idle state in the first mode and a case where the decision section has determined that the first and second control sections are in the idle state in the second mode.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 schematically shows a unit which uses a card wireless communication apparatus according to an embodiment of the present invention.

FIG. 2 is a functional block diagram showing an embodiment of the host unit 1 and SD IO card 2 in FIG. 1.

FIG. 3 is a functional block diagram showing an embodiment of the control section 13 of FIG. 2.

FIG. 4 schematically shows a protocol stack for a Bluetooth module implemented in the SD IO card 2 of FIG. 2.

FIG. 5 schematically shows an operating state in the THIN mode.

FIG. 6 is a flowchart to help explain the processing procedure of the SD IO card 2 in the state of FIG. 5.

FIG. 7 schematically shows an operating state in the FAT mode.

FIG. 8 is a flowchart to help explain the processing procedure of the SD IO card 2 in the state of FIG. 7.

### DETAILED DESCRIPTION OF THE INVENTION

FIG. 1 schematically shows a unit which uses a card wireless communication apparatus according to an embodiment of the present invention. Numeral 1 in FIG. 1 indicates a host unit, such as a mobile phone terminal or a PDA, which is driven by a built-in power supply. Numeral 2 indicates the card wireless communication apparatus (hereinafter, referred to as the SD IO card), which is installed in the host unit 1 via a slot. In FIG. 1, the SD IO card 2 has a Bluetooth module implemented therein. An SD interface is provided between the host unit 1 and the SD IO card 2.

In the embodiment, suppose a card wireless communication apparatus has two operation modes, Type-A mode and Type-B mode. That is, the apparatus is a Type-B card. Both Type-A mode and Type-B mode have been formulated in the SD IO cards for Bluetooth specifications. In cards of this type, Type-A mode may be called THIN mode and Type-B mode may be called FAT mode. In the embodiment, too, these names are used.

The SD IO card 2 has two operation modes, THIN mode and FAT mode. Switching between these operation modes is selectively done, depending on whether a high-order protocol stack related to the SD IO cards for Bluetooth specifications has been implemented in the host unit 1. If the high-order protocol stack has been implemented in the host unit 1, the SD IO card 2 is started in the THIN mode. If the high-order protocol stack has not been implemented in the host unit 1, the SD IO card 2 is started in the FAT mode. The SD IO card 2 itself makes a decision whether the high-order protocol stack has been implemented in the host unit 1 and does the switching between the operation modes.

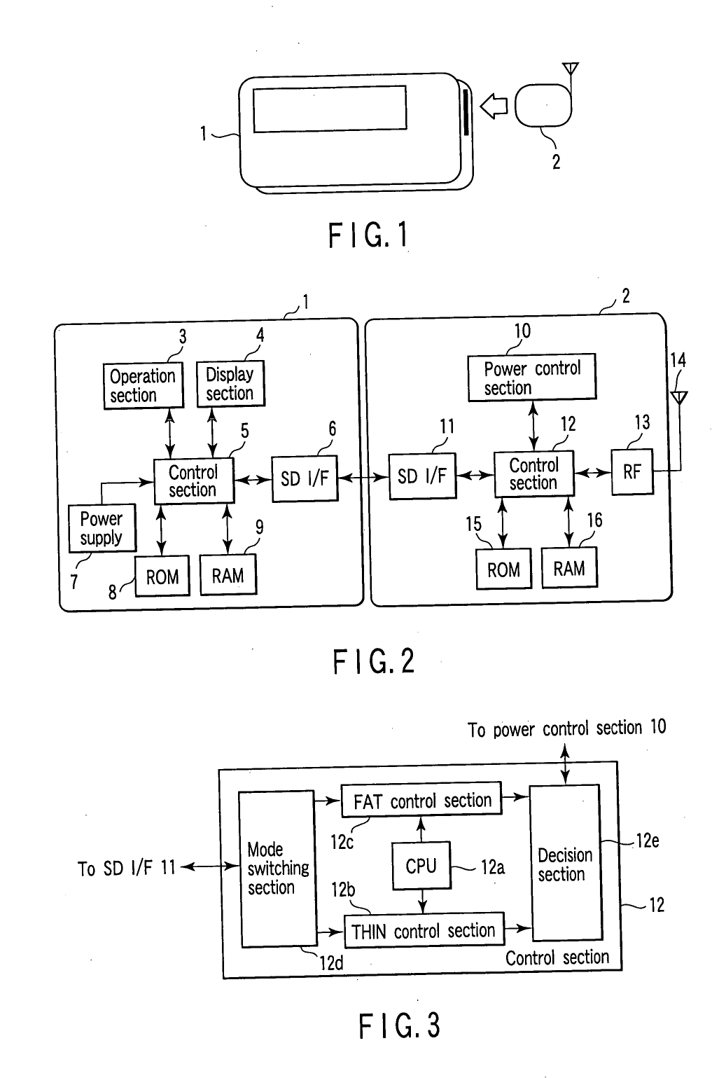

FIG. 2 is a functional block diagram showing an embodiment of the host unit 1 and SD IO card 2 in FIG. 1. In FIG. 2, the host unit 1 comprises an operation section 3, a display section 4, a control section 5, an SD interface (I/F) 6, a power supply 7, a ROM (Read Only Memory) 8, and a RAM (Random Access Memory) 9.

The operation section 3, which includes a keypad and the like (not shown), enables the user to operate the host unit 1. The display section 4 shows the information outputted from the host unit 1 to the user. The control section 5 supervises control of the entire host unit 1. The SD I/F 6 is an interface for enabling the exchanging of data and control information between the host unit 1 and SD ID card 2 and for enabling the host unit 1 to supply driving electric power to the SD IO card 2. The power supply 7, which is a battery built in the host unit 1, supplies driving electric power to the host unit 1 and SD IO card 2. The ROM 8 and RAM 9 store programs and data for controlling the host unit 1.

The SD IO card 2 includes a power control section 10, an SD I/F 11, a control section 12, a wireless (RF) I/F 13, an antenna 14 connected to the I/F 13, a ROM 15, and a RAM 16.

The power control section 10 supervises control of the electric power for two units of the SD IO card 2 on the basis of the power supplied from the host unit 1. The SD I/F 11 is an interface for enabling the exchanging of data and control information between the SD IO card 2 and the host unit 1 and for receiving the driving electric power from the host unit 1. The control section 12 supervises baseband control, a link controller, and a wireless communication process. The wireless I/F 13 modulates and demodulates a radio frequency signal inputted or outputted via the antenna 14 and inputs and outputs the resulting signal to and from the control section 12. The ROM 15 and RAM 16 store programs and data for wireless communication and data transfer.

FIG. 3 is a functional block diagram showing an embodiment of the control section 13 of FIG. 2. The control section 12 includes a CPU 12a, a THIN control section 12b, a FAT control section 12c, a mode switching section 12d, and a decision section 12e.

The CPU 12a, which uses the power supplied from the host unit 1, supervises control of the operation of the SD IO card 2. The CPU 12a realizes a power-saving mode in addition to the normal operation modes. In the power-saving mode, the clock frequency of the CPU 12a is lowered, thereby suppressing the power consumption.

The THIN control section 12b causes the CPU 12a to carry out a process related to Link Controller, Link Manager, and HCI formulated in the SD IO cards for Bluetooth specifications. In addition, the THIN control section 12b causes the CPU 12a to carry out a process related to the THIN I/F in order to interface these low-order protocol stacks with the SD I/O. The FAT control section 12c causes the CPU 12a to carry out a process related to HCI, L2CAP, RFCOMM, and SDP formulated in the SD IO cards for Bluetooth specifications. In addition, the FAT control section 12c causes the CPU 12a to carry out a process related to the FAT I/F in order to interface these high-order protocol stacks with the SD I/O.

In the THIN mode, only the THIN control section 12b is started mostly. In the FAT mode, not only the THIN control section 12b but also the FAT control section 12c is started. The FAT mode is realized by a cooperative operation between the THIN control section 12b and the FAT control section 12c.

The mode switching section 12d senses via the SD I/F 11 whether a high-order protocol stack (such as HCI, L2CAP, RFCOMM, or SDP) has been implemented in the host unit 1. If a high-order protocol stack has been implemented in the host unit 1, the mode switching section 12d starts the THIN control section 12b, thereby operating the SD IO card 2 in the THIN mode. As a result, a Bluetooth wireless communication environment is formed between the host unit 1 and the other party (e.g., an external device (not shown)) with which the host unit 1 communicates.

If no high-order protocol stack has been implemented in the host unit 1, the mode switching section 12d starts the THIN control section 12b and FAT control section 12c, thereby operating the SD IO card 2 in the FAT mode. In this case, too, a Bluetooth wireless communication environment is established between the host unit 1 and an external device.

The decision section 12e monitors the operating state of the THIN control section 12b and FAT control section 12c and determines whether each of the THIN control section 12b and FAT control section 12c stands idle. The result of the determination is notified to the power control section 10 (see FIG. 2). If it has been determined that the THIN control section 12b is in the idle state in the THIN mode, the power control section 10 brings the CPU 12a into the power-saving mode. If both of the THIN control section 12b and the FAT control section 12c are in the idle state in the FAT mode, the power control section 10 brings the CPU 12a into the power-saving mode.

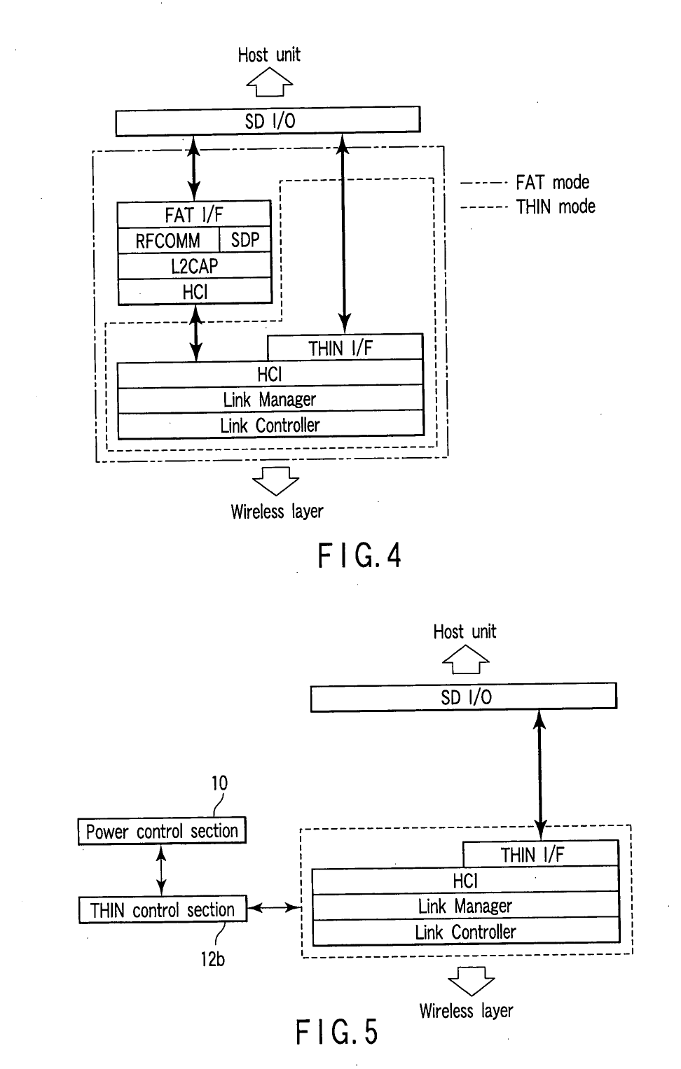

FIG. 4 schematically shows a protocol stack for a Bluetooth module implemented in the SD IO card 2 of FIG. 2. The SD IO card 2 supports both interfaces, RFCOMM and HCI, shown in FIG. 4, to support the SD interface. For Bluetooth physical layers, frequency-hopping spectrum spread modulation using a 2.4-GHz frequency band is adopted.

As shown in the part enclosed by a dotted line in FIG. 4, the SD IO card with only the THIN mode (Type-A card) links with a wireless layer (Link Controller) near a physical layer and then implements Link Manager, HCI, and THIN I/F higher in level than the Link Controller. As shown in the part enclosed by a two-dots-dash line in FIG. 4, the SD IO card with the THIN mode and FAT mode (Type-B card) links with HCI in a lower-level layer and then implements L2CAP, RFCOMM, SDP, and FAT I/F. The process of each of the layers is linked with the host unit 1 via the SD I/O.

As described above, the SD IO card 2 is started in the FAT mode or the THIN mode according to the instruction from the host unit 1. In the THIN mode, layers lower than HCI become active. In the FAT mode, L2CAP and RFCOMM also become active by way of the SD interface 11.

FIG. 5 schematically shows an operating state in the THIN mode. In the THIN mode, the THIN control section 12b is started and the process related to Link Controller, Link Manager, HCI, and THIN I/F is carried out at the SD IO card 2.

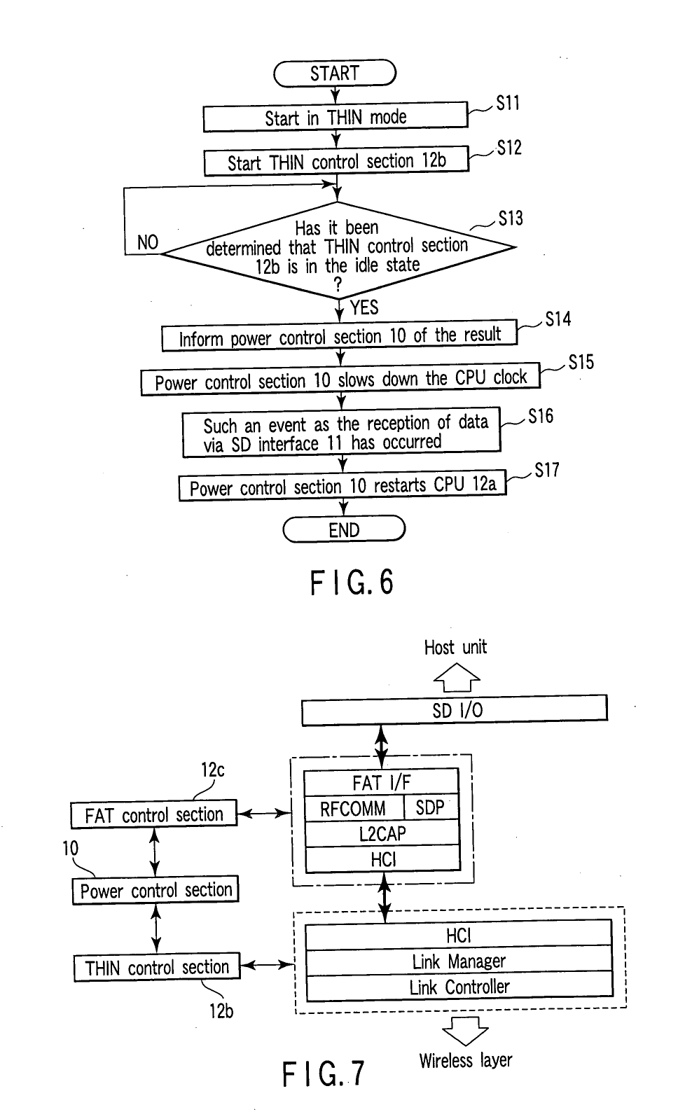

FIG. 6 is a flowchart to help explain the processing procedure of the SD IO card 2 in the state of FIG. 5. When the SD IO card 2 is started in the THIN mode (step S11), then the THIN control section 12b is started (step S12). The THIN control section 12b manages the presence and absence of Bluetooth link connections, the presence and absence of data transmitted from the host unit 1 via the SD I/F 11, and the presence and absence of an internal timer.

The decision section 12e waits for the THIN control section 12b to go into the idle state (step S13). That is, the decision section 12e monitors the state of the THIN control section 12b. If having determined that the CPU 12a can be brought into the power-saving mode (Yes in step S13), the decision section 12e informs the power control section 10 of the result of the determination (step S14).

Receiving the result of the determination, the power control section 10 makes the clock frequency of the CPU 12a lower than usual, thereby bringing the CPU 12a into the power-saving mode (step S15). Thereafter, if an invent, such as the arrival of the data from the host unit 1 via the SD I/F 11, has occurred (step S16), the power control section 10 returns the clock frequency of the CPU 12a to the normal value immediately and starts the CPU 12a again (step S17).

FIG. 7 schematically shows an operating state in the FAT mode. In the FAT mode, the THIN control section 12b and FAT control section 12c are started. Therefore, the processing of the high-level layer related to not only Link Controller, Link Manager, and HCI but also HCI, L2CAP, RFCOMM, SDP, and FAT I/F is effected at the SD IO card 2.

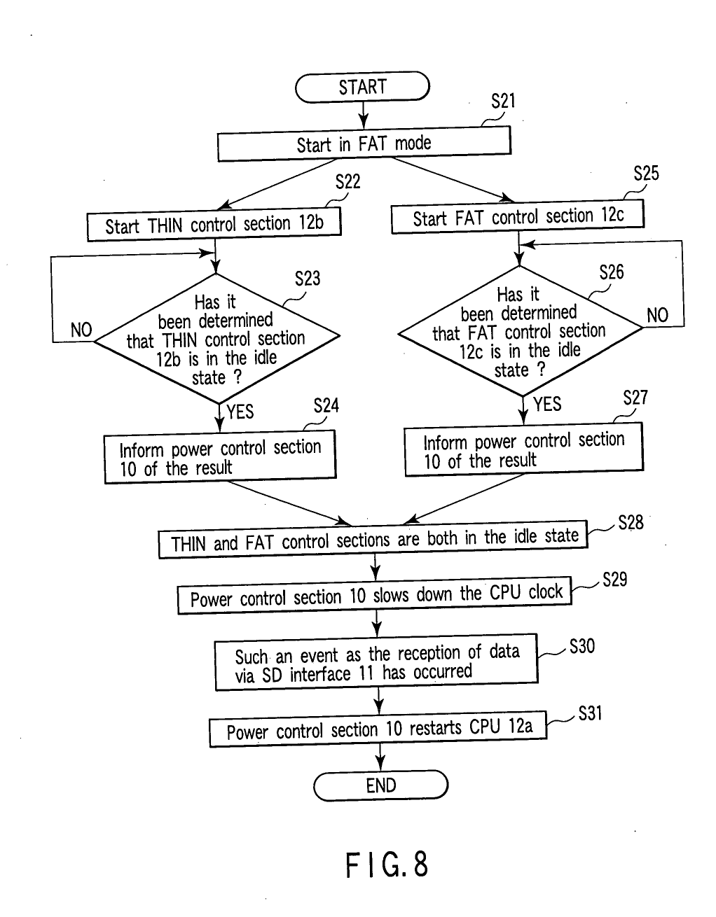

FIG. 8 is a flowchart to help explain the processing procedure of the SD IO card 2 in the state of FIG. 7. In FIG. 8, when the SD IO card 2 is started in the FAT mode (step S21), not only the THIN control section 12b but also the FAT control section 12c are started (steps S22 and S25). When the decision section 12e has determined that the THIN control section 12b has changed from this state to the idle state (step S23), it informs the power control section 10 of the change of the state (step S24).

The FAT control section 12c not only monitors the state of RFCOMM and the state of L2CAP but also manages information about the presence and absence of a logical connection with the host unit 1. The decision section 12e monitors the state of the FAT control section 12c and waits for the FAT control section 12c to go into the idle state (step S26). That is, the decision section 12e monitors the state of the FAT control section 12c. When having determined that the CPU 12a can be set in the power-saving mode (Yes in step S26), the decision section 12e informs the power control section 10 of the result of the determination (step S27).

When the power control section 10 is informed by the decision section 12e that the THIN control section 12b and the FAT control section 12c are both in the idle state (step S28), the power control section 10 concludes that both of the control sections 12b, 12c can be brought into the power-saving mode. Then, the power control section 10 makes the clock of the CPU 12a slower than in the normal operation, thereby bringing the CPU 12a into the power-saving mode (step S29). After this, if such an event as the arrival of the data from the host unit 1 via the SD I/F 11 has occurred (step S30), the power control section 10 returns the clock frequency of the CPU 12a to the normal value immediately and starts the CPU 12a again (step S31).

To sum up, when the THIN control section 12b stands idle in the THIN mode, the CPU 12a goes into the power-saving mode. Similarly, when the thin control section 12b and FAT control section 12c both stand idle in the FAT mode, the CPU 12a goes into the power-saving mode. That is, even when Bluetooth is started in either the THIN mode or the FAT mode, the optimum power control can be performed in the present mode. This makes it possible to perform power control minutely according to the starting mode of Bluetooth, which enables the power consumption of the host unit 1 to be suppressed.

As described above, in the embodiment, the THIN control section 12b which carries out the process of the low-order protocol stack related to the SD IO cards for Bluetooth specifications and the FAT control section 12c which carries out the high-order protocol stack are provided in the SD IO card 2. The decision section 12e monitors the THIN control section 12b and the FAT control section 12c separately. If the THIN control section 12b is in the idle state in the THIN mode, the CPU 12a is brought into the power-saving mode. If the THIN control section 12b and the FAT control section 12c are both in the idle state in the FAT mode, the CPU 12a is brought into the power-saving mode.

Specifically, the SD IO card 2 determines whether its starting mode is the THIN mode or the FAT mode. According to the result of the determination, the operating state of the THIN control section 12b and that of the FAT control section 12c are monitored. Particularly in the FAT mode, only when the THIN control section 12b and FAT control section 12c both stand idle, the CPU 12a is brought into the power-saving mode. Therefore, in any one of the THIN mode and the FAT mode, the power consumption can be controlled optimally, which enables the power consumption of the host unit 1 to be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A card wireless communication apparatus which has an interface installable in a host unit and conforms to communication standards where a high-order protocol stack including an adaptable protocol to emulate serial port communication and a low-order protocol stack closer to a physical layer than the high-order protocol stack have been formulated, the card wireless communication apparatus comprising:
a processor which receives electric power from the host unit and operates;
a first control section which causes the processor to carry out a process related to the low-order protocol stack;
a second control section which causes the processor to carry out a process related to the high-order protocol stack;
a mode switching section which starts the first control section in a first mode corresponding to a case where the apparatus is installed the host unit in which the high-order protocol stack is implemented and establishes a wireless communication environment in the first mode between the host unit and an external unit and which starts the first and second control sections in a second mode corresponding to a case where the apparatus is installed in the host unit in which the high-order protocol stack is not implemented and establishes a wireless communication environment in the second mode between the host unit and the external unit;
a decision section which determines whether the operating state of the first control section is idle and whether the operating state of the second control section is idle; and
a power control section which brings the processor into a power-saving mode, in one of a case where the decision section has determined that the first control section is in the idle state in the first mode and a case where the decision section has determined that the first and second control sections are in the idle state in the second mode.

2. The card wireless communication apparatus according to claim 1, wherein the communication standards adopt a frequency hopping spectrum spread system using a 2.4-GHz frequency band for the physical layer.

3. The card wireless communication apparatus according to claim 1, wherein the apparatus conforms to SD IO cards for Bluetooth specifications.

4. The card wireless communication apparatus according to claim 2, wherein the apparatus conforms to SD IO cards for Bluetooth specifications.

5. The card wireless communication apparatus according to claim 1, wherein the first mode is a Type-A mode corresponding to Type-A card specification defined in the SD IO cards for Bluetooth specifications.

6. The card wireless communication apparatus according to claim 1, wherein the second mode is a Type-B mode corresponding to Type-B card specification defined in the SD IO cards for Bluetooth specifications.

7. An electric power control method for a card wireless communication apparatus which has an interface installable in a host unit and a processor receiving electric power from the host unit and conforms to communication standards where a high-order protocol stack including an adaptable protocol to emulate serial port communication and a low-order protocol stack closer to a physical layer than the high-order protocol stack have been formulated, the electric power control method comprising:
a first starting step of causing the processor to carry out a process related to the low-order protocol stack in a first mode corresponding to a case where the card wireless communication apparatus is installed in the host unit in which the high-order protocol stack is implemented;
a first decision step of determining whether a process related to the low-order protocol stack stands idle after the first starting step; and
a shift step of bringing the processor into a power-saving mode when it has been determined in the first decision step that a process related to the low-order protocol stack stands idle.

8. The electric power control method according to claim 7, wherein the card wireless communication apparatus conforms to SD IO cards for Bluetooth specifications.

9. The electric power control method according to claim 7, further comprising:
a second starting step of causing the processor to carry out a process related to the low-order protocol stack and a process related to the high-order protocol stack in a second mode corresponding to a case where the card wireless communication apparatus is installed in the host unit in which the high-order protocol stack is not implemented; and
a second decision step of determining whether a process related to the low-order protocol stack stands idle and whether a process related to the high-order protocol stack stands idle after the second starting step,
wherein the shift step is a step of bringing the processor into the power-saving mode when it has been determined in the second decision step that a process related to the low-order protocol stack and a process related to the high-order protocol stack both stand idle.

10. The electric power control method according to claim 9, wherein the card wireless communication apparatus conforms to SD IO cards for Bluetooth specifications.

11. The electric power control method according to claim 7, wherein the communication standards adopt a frequency hopping spectrum spread system using a 2.4-GHz frequency band for the physical layer.

12. The electric power control method according to claim 9, wherein the communication standards adopt a frequency hopping spectrum spread system using a 2.4-GHz frequency band for the physical layer.

13. The electric power control method according to claim 7, wherein the first mode is a Type-A mode corresponding to Type-A card specification defined in the SD IO cards for Bluetooth specifications.

14. The electric power control method according to claim 9, wherein the second mode is a Type-B mode corresponding to Type-B card specification defined in the SD IO cards for Bluetooth specifications.
